(19) United States
(12) Patent Application Publication
(10) Pub. No.: US 2014/0000584 A1
(43) Pub. Date: Jan. 2, 2014

(54) FIXING SYSTEM FOR CONNECTING TWO COMPONENTS TO EACH OTHER AND METHOD FOR FIXING A MIRROR ELEMENT, IN PARTICULAR FOR A SOLAR COLLECTOR MODULE, TO A SUPPORT FRAME USING SUCH FIXING SYSTEMS

(71) Applicants: Christoph Raucher, Hohr-Grenzhausen (DE); Paul Nava, Troisdorf (DE); Andreas Wohlfahrt, Ludinghausen (DE); Gerd Kuhlmann, Dortmund (DE); Klaus Hogerl, Furth im Wald (DE)

(72) Inventors: Christoph Raucher, Hohr-Grenzhausen (DE); Paul Nava, Troisdorf (DE); Andreas Wohlfahrt, Ludinghausen (DE); Gerd Kuhlmann, Dortmund (DE); Klaus Hogerl, Furth im Wald (DE)

(73) Assignee: Flabeg Holding GmbH, Furth im Wald (DE)

(21) Appl. No.: 13/994,454

(22) PCT Filed: Dec. 16, 2011
(86) PCT No.: PCT/EP2011/006384

§ 371 Date: Sep. 23, 2013

(30) Foreign Application Priority Data
Dec. 17, 2010 (DE) 10 2010 054 980.0

(51) Int. Cl. F24J 2/52; F16B 17/00; B23P 19/04

(52) U.S. Cl. CPC F24J 2/52; B23P 19/04; F16B 17/00
USPC 126/696; 29/525.01; 29/525.15; 403/345; 403/376

(57) ABSTRACT

A fastening system for connecting two components to each other, which is particularly suitable for attaching mirror elements of a solar collector module to a support frame, and which enables in particular simple handling during assembly of the components, includes a base provided with an upwardly projecting locking pin and intended for mounting on one of the components, and a cylindrical casing forming a receiving channel for the locking pin and intended for mounting on the other component. When the locking pin is inserted in the receiving channel, the cylindrical casing forms in conjunction with the base plate a receptacle for liquid adhesive.

Fastening system for connecting two components with each other and method for fastening a mirror element, especially for a solar collector module, to a support frame using such fastening systems

The invention relates to a fastening system for connecting two components with each other. The invention furthermore relates to a solar collector module having a plurality of mirror elements fastened to a support frame by using such fasteners and a method for fastening mirror elements on a support frame by using such fastening systems.

Solar collector modules each having a plurality of mirror elements are used in the context of so-called parabolic trough power plants, wherein all the solar collector modules are arranged on a common support frame to form a parabolic mirror. The solar collector modules are usually aligned in North-South direction and uniaxially follow the sun, wherein the mirror elements due to their arrangement in form a parabolic mirror concentrate the incident solar radiation onto an absorber tube extending in the focal line. Temperatures of up to 550° C. can thus be achieved in the absorber tube that extends in the focal line. The heat introduced thereby into the absorber tube can be dissipated via a working medium and converted via connected heat exchangers, for example, into superheated steam that drives coupled generators by using conventional power plant technology. In this way, such parabolic trough power plants form solar power plants for providing centralized power, wherein efficiency ranges of, for example, between 10 and 100 MW or more are achievable, depending on the design and positioning of plant. Collectors having, for example, a total length of up to 150 m may be created by sequentially connecting a plurality of solar collector modules of the aforementioned type.

A highly accurate alignment of the mirror elements provided for the formation of the parabolic mirror on the support frame is particularly important for the proper operation and high efficiency of such a parabolic trough power plant. In particular, a precise adjustment of individual mirror elements with respect to the parabolic cross-sectional shape of the solar trough collector defined as “ideal line” is particularly important for a reliable concentration of the incident solar radiation on the absorber tube extending in the focal line. Therefore, there is a general desire to ensure a highly accurate alignment of the mirror elements in their mount on the support frame in the production and/or assembly of the solar collector modules intended for use in such a parabolic trough power plant.

For this purpose, it is in principle possible to install the mirror elements in their support frames on-site, i.e. directly at the intended location, and to directly make the fine adjustment using suitable adjusting aids, such as screws or the like. In particular in view of the large number of individual solar collector modules provided in the setup of a parabolic trough power plant of the aforementioned type and their constituent mirror elements and also in view of the relatively large area covered by the power plant, such on-site installation including the fine alignment of the respective components, however, involves considerable complexity and expense.

For sake of simplification, it may therefore be desirable to provide in advance a centralized pre-assembly of individual solar collector modules when designing the solar collector modules for such a parabolic trough power plant, so that a subsequent field installation can be performed with relatively little effort and without additional adjustment and alignment work. To ensure that the already made highly precise adjustment and alignment of the individual mirror elements during pre-assembly remains reliable unchanged even after transport to the actual location, the mirror elements should be fastened on the support frame largely stress-free, yet highly accurate and sufficiently permanent and stable. As has been found in the meantime, these criteria cannot be met in a satisfactory manner when using conventional screw connections for fastening the mirror elements on the support frames.

To remedy this, a fastening method that can also be used for fastening mirror elements of a solar collector module to its support frame is known from WO 2009/106103 A1, wherein the components can be connected to each other by resorting to a bonding technique. In this method, a container for receiving the adhesive is attached to one of the components to be joined and the other component to be joined is moved with a corresponding joining surface into the interior of this container. The container is subsequently filled with the adhesive, which is then cured.

It is the object of the invention to provide a fastening system for connecting two components with one another, which in view of the specified criteria is particularly suited for fastening mirror elements of a solar collector module of the aforedescribed type on a support frame and which enables easier handling during assembly of the components compared to the aforementioned joining method. In addition, a particularly suitable method for fastening a mirror element, in particular for a solar collector module, on a support frame by using such fastening systems is to be provided.

This object is attained with respect to the fastening system with a base plate configured for attachment to one of the components, and with a casing configured for attachment on the other component and forming a receiving channel for a connector body, wherein the casing in conjunction with the base plate forms a receptacle for liquid adhesive.

The invention is based on the concept that for a stress-free, highly accurate alignment and adjustment during attachment of the mirror element on the support frame of the solar collector module and adhesives method is used intentionally as a deliberate departure from usually employed screw connections or the like. By resorting to initially liquid adhesive, which after mutually adjustment and positioning of the components is incorporated in a suitable receptacle and cured therein to form a connector body, the connector body may be provided with an external shape as needed, which receives and maintains the actual positioning of the components. The fastening system should be adapted to provide a receptacle for the liquid adhesive, which is given its final shape and geometry only after the final alignment and positioning of the components relative to each other and precisely as a result of this fine adjustment, so that the thermosetting adhesive can precisely accommodate and fix this spatial shape. For this purpose, the receptacle may be formed by several components, of which at least one component is affixed to each of the components to be joined, before the components are fine-aligned and positioned relative to each other.

Advantageously, the base plate is provided with an upstanding locking pin, wherein the casing forms the receptacle only after the locking pin has been inserted into the receiving channel. In this way, the components can be fine-aligned with high precision relative to each other when the respective elements of the fastening system, i.e. particular when the locking pin connected with the respective first component, is inserted into the corresponding receiving channel of the casing of the respective other component, tension-free and substantially without introducing external forces, because the locking pin can move unconstrained within the receiving channel of the casing within limits in all spatial directions (x, y and z directions), while rotations about the x, y and/or z-axis are also possible (so-called six-axis adjustment). The components, i.e. in particular the respective mirror element, can thus be fine-aligned relative to the support frame, completely and without the introduction of forces into the fastening system, even when the locking pin has been inserted in the receiving channel, wherein the locking pin assumes a proper position within the receiving channel.

To allow in particular easier handling of the entire system, it should also be possible to ultimately fill the adhesive into the receiving channel in a particularly simple manner and in particular without interference by the locking pin when the locking pin is inserted in the receiving channel. To ensure this, the fastening system should enable filling of the receiving channel, when the locking pin is inserted, from the side facing away from the locking pin, i.e. “from the back side”. This can be attained by forming the receptacle for the adhesive only after assembling the components, i.e. by the end region of the casing forming the receiving channel, on one hand, in conjunction with the base plate supporting the locking pin. In this way, during assembly of the system, the individual elements, i.e. the casing on one hand and the base plate with the locking pin on the other hand, are each initially attached separately to the components to be joined, i.e. the support frame and the mirror element, and only thereafter assembled to form the receptacle.

In addition, a particularly high mechanical strength and stiffness of the assembled system can be attained with this arrangement of the components. Because the locking pin is already rigidly mechanically connected to the base plate supporting the locking pin, the force between the components is transmitted via, on one hand, the components base plate/locating pin and, on the other hand, the casing. Relevant for the stiffness of the system with respect to transverse or shear forces is therefore not only the comparatively small cross-section of the locking pin, but the relatively much larger cross-section of the casing. Furthermore, a sufficiently large quantity of the adhesive can be filled into the receptacle formed by the cooperating base plate and casing so as to completely surround the locking pin protruding into the receiving channel in the casing. This ensures that there is no force transmission or torque transmission via the locking pin which has a relatively thin cross-section at any point of the force- and torque-transmitting system.

In a particularly advantageous embodiment, the adhesive may be a polyurethane adhesive, preferably a two-component polyurethane adhesive.

For a particularly reliable and durable assembly and connection of the components to each other, i.e. in particular for attachment of the mirror element on the support frame, the fastening system should also be designed—in particular after curing of the adhesive filled in the receptacle formed by the casing and the base plate—for a comparatively high tensile load. To this end, the fastening system is advantageously configured, in addition to adhesively and materially bonding the components to one another, also for providing a positive connection of the components to one another, in particular by way of respective undercuts. Especially after the adhesive has cured and the resulting solid body is formed in the receptacle in the region of locking pin, on one hand, and the surrounding casing, on the other hand, this can be particularly advantageously achieved by suitably contouring the locking pin, on one hand, and/or the surrounding interior surface of the casing, on the other hand.

To form such undercuts, the locking pin is advantageously provided with suitable surface contouring, which can be provided, for example—when the locking pin is formed by mounting screw extending the base plate—by a screw thread or possibly also by additional contouring. In an alternative or additional advantageous embodiment, the inner surface of the casing may have corresponding openings, circumferential grooves or the like for forming a suitable contour. Hot-dip galvanizing of the inner surface of the casing may also provide a comparatively fine surface contouring for increased surface roughness. In alternative or additional advantageous embodiment, the end region of the casing may be provided with an suitable cross-sectional constriction of the receiving channel to form an undercut of the aforedescribed type, for example in the form of an inwardly facing shoulder in the region of the opening.

In an alternative embodiment, the fastening system can also be designed to eliminate the locking pin or add functionality to the locking pin so as to meet the mechanical demands on the joint, in particular the stability to shear forces and/or a tensile or compressive load in the longitudinal direction of the receiving channel by way of the connector body formed by the cured adhesive alone. To this end, the receptacle formed by the casing in conjunction with the base plate for the liquid adhesive can be shaped so that the connector body produced by curing the adhesive is positively connected with the components forming the receptacle against both transverse forces and tensile stresses in the longitudinal direction. The components are advantageously designed so as to form suitable undercuts.

This can be achieved with respect to the first component, i.e. the casing, by advantageously providing a receiving channel arranged in the casing with an undercut region having an enlarged inner cross-sectional area compared to mouth portion facing the base plate. As seen from the “free” or open end of the receiving channel, the receiving channel has a comparatively smaller free opening cross-section which widens in the longitudinal direction of the receiving channel in the undercut located farther inward. In an additional or alternative advantageous embodiment, the base plate is provided with a passage opening in the contact area to the mouth of the receiving channel through which the liquid adhesive can pass when the receptacle is filled. A base well is preferably provided on the rear side of the base plate, which has on the side of the base plate facing away from the casing a collecting chamber for the adhesive passing through the passage opening.

Precisely by combining these measures, a connector body in form of a two-sided stamp is formed during curing of the filled adhesive, which is thus positively connected both to the casing and with the base plate.

Due to the design of the fastening system with the locking pin and connector body, on one hand, and the casing surrounding the locking pin and connector body, on the other hand, the system components can be easily fine-aligned relative to one another in the cross-sectional plane of the receiving channel by the corresponding agility of the relevant components in this plane. In order also facilitate the limited agility of the components relative to one another, in particular the locking pin within the receiving channel, in the longitudinal direction of the receiving channel while still allowing the formation of the receptacle for the liquid adhesive by the casing and the base plate, a suitable flexible elastic sealing or buffer element is advantageously disposed in the region before the end mouth of the receiving channel and the base plate. This elastic sealing or buffer element is advantageously made of a material that is elastic compared to the material of the base plate and/or the casing, such as foam, so that when the components are fine-aligned relative to each other, i.e. in a relative movement of the locking pin and the supporting base plate relative to the receiving channel as viewed in its longitudinal direction, the sealing or buffer element is a more or less strongly compressed, thereby ensuring sufficient leak-tightness of the receptacle formed by the base plate and the casing for filling with liquid adhesive.

In a particularly advantageous embodiment, the buffer element is made of several components, wherein the respective components are designed specifically for a particular functionality. In particular, a first of the components is advantageously designed for at least temporarily sealing the receptacle formed by the base plate and casing for filling with a liquid adhesive, and has accordingly a sealing barrier for a comparatively high leak-tightness for the adhesive. Conversely, a second of the components is preferably designed to accommodate the aforementioned deformation and is, accordingly, designed for a relatively high ductility and therefore increased elasticity. Advantageously, the first component of the buffer element has a lower elasticity and ductility and a higher density. In one embodiment of the buffer element based on foam, this may in particular be achieved by constructing the first component in the manner of a closed-pore sealing area, whereas the second component is designed open-pore or mixed-pore. Preferably, the components are materially connected to each other, for example glued or welded together.

In an alternative or additional advantageous embodiment, the buffer element has a three-dimensional shape in the shape of a bell or sleeve. With such a shape, the requirements, particularly with respect to deformability, regarding sealing, compensation of tolerances, relatively low residual forces, and the like, are satisfied primarily by the geometry of the buffer element and optionally additionally by the choice of its materials. Due to the shape of the bell or the sleeve, the buffer element should be in the form of a channel with a cross-section that widens in the longitudinal direction. When using a suitable flexible material, longitudinal and lateral forces can be absorbed through a suitable deformation of the channel wall, without causing excessively large restoring forces in the end regions of the buffer element.

The fastening system is generally designed so that after the receptacle formed by the base plate and the casing is filled with the liquid adhesive and the liquid adhesive has cured, a permanent and non-detachable connection of the components with one another is formed. In order to still allow an exchange of individual elements when needed, for example, when the mirror element within the parabolic trough power plant or the like is damaged, the fastening system is advantageously designed to provide an additional, releasable connection for connecting the components to one another. For this purpose the mounting plate advantageously includes, in addition to the first contact plate provided for connection to the casing, an additional contact plate for attachment to the respective component. This additional contact plate arranged at the side of the first contact plate may be connected with the actual component, i.e. the mirror element, for example, via a screw connection or the like. This screw connection may be applied first during assembly of the mirror element, so that the mirror element is connected to the additional contact plate, and thus to the base plate. The mirror element can then be attached on the support frame in the aforedescribed manner by using the intended adhesive bond. If required, the screw connection of the mirror element with the additional contact plate arranged on the side to the actual adhesive bond can then be later released and the mirror element can be replaced if necessary.

To simplify in such a system the accessibility of the screw connection with the mirror element and also the subsequent replacement of the mirror elements in the aforedescribed manner, the additional contact plate is advantageously bent where it is attached to the first contact plate. Furthermore, the additional contact plate advantageously has an assembly stop which can be brought into contact with a corresponding assembly stop on the mirror element, so that the contact plate can be easily adjusted when the mirror element is attached, much like a reference.

The important components of the fastening system, in particular the locking pin, the base plate and the casing, may be made of essentially the same material, for example galvanized steel or another other metal. Advantageously, however, the locking pin is designed as a flexurally softer or more flexible element compared to the casing, in particular a multi-fiber element, preferably made of a more elastic material in comparison with the casing. With this increased flexibility or elasticity of the locking pin in comparison to the casing achieved by suitable dimensioning and/or choice of material, it is ensured that in the event of a collision of the two elements, for example during assembly, the locking pin yields with a predetermined deviation and suitably deforms. Damage to the relatively sensitive mirror elements is thus reliably avoided in a collision of the components during the assembly.

Advantageously, the fastening system is used for fastening mirror elements on a support frame to form a solar collector module.

Regarding the method, the above object is solved by attaching first the base plate on the mirror element and then the casing to the support frame, whereafter the mirror element is adjusted relative to the support frame so that the casing together with the base plate forms a receptacle for the liquid adhesive, which is then filled with the liquid adhesive.

The advantages achieved with the invention are that in particular with the configuration of the components of the fastening system, in particular through the cooperation between casing, on one hand, and the base plate, on the other hand, construction of a receptacle for the liquid adhesive and the use of adhesive technology as a joining technique for fastening mirror elements on their support frame to form a solar collector module are significantly simplified. In particular, this configuration of the components makes it possible, after the formation of the receptacle for the liquid adhesive, i.e. after the casing is suitably brought into contact at the end face with the base plate, to fill the receptacle from the back side with the liquid adhesive without interference from the optionally provided locking pin or other components, so that the mirror element can be fastened on the support frame in a particularly simple manner and with a high processing speed and hence suitable for very high volumes. The adhesive bonding technique can thus be readily used on a large scale, so that the advantages thereof can be used during the alignment and fine-adjustment of the mirror elements on the support frame on a large scale, i.e. in particular for a stress-free and force-free installation.

In addition, when filling the receptacle formed by the cooperation of the base plate and the casing, a sufficiently large quantity of the adhesive can be filled so that as to form, after curing, a sufficiently large connector body capable of sustaining mechanical strain and/or optionally completely enclosing the locking pin protruding into the receiving channel. This ensures that forces or moments are not transferred at any point of the force- and torque-transmitting system exclusively by way of the locking pin, which has a comparatively thin cross-section, so that the system as a whole has a particularly high rigidity and resistance to lateral forces. Among other things, this also increases the resistance to warping of the material during hot-dip galvanizing or damage during transport. In addition, the optionally provided locking pin is after installation particularly well protected against corrosion due to the complete coating with adhesive.

With this increased rigidity, the casings or sleeves can now be designed for a vertical installation position in the assembly process which can therefore be simplified (through vertical lowering of the support frame on the mirror element). The locking pins then need no longer be aligned perpendicular to the mirror surface due to the exceedingly low rigidity of the system components. By constructing the casing as a hollow profile (i.e. through formation of the receiving channel), the line of force of the casing may now be located in the plane of the support frame constructed as a framework, so that the forces present can be introduced into the plane of the framework without producing additional bending moments transverse to the plane of the framework. The support frame or support frame may then be constructed comparatively thinner and thus with less material.

An exemplary embodiment of the invention will be described in more detail with reference to a drawing. The drawing shows in:

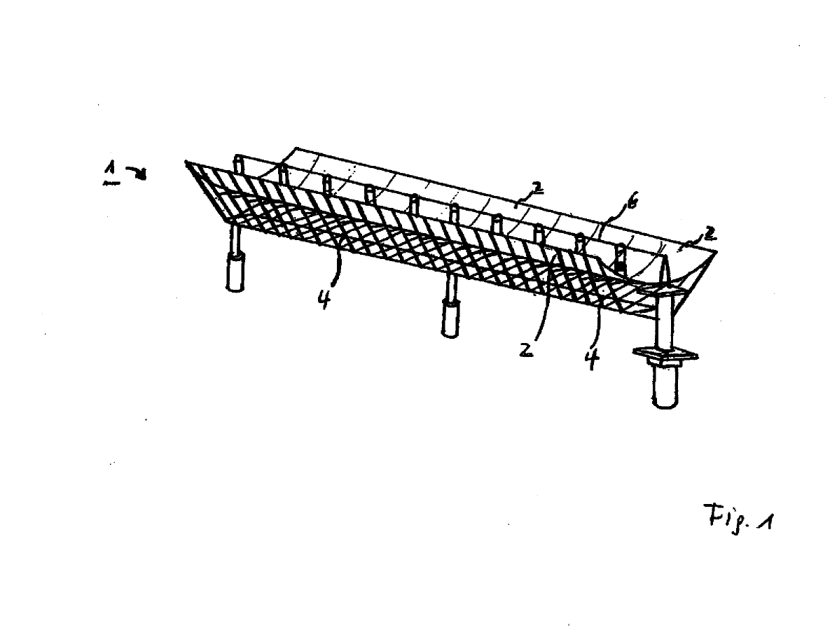

FIG. 1 a solar collector module,

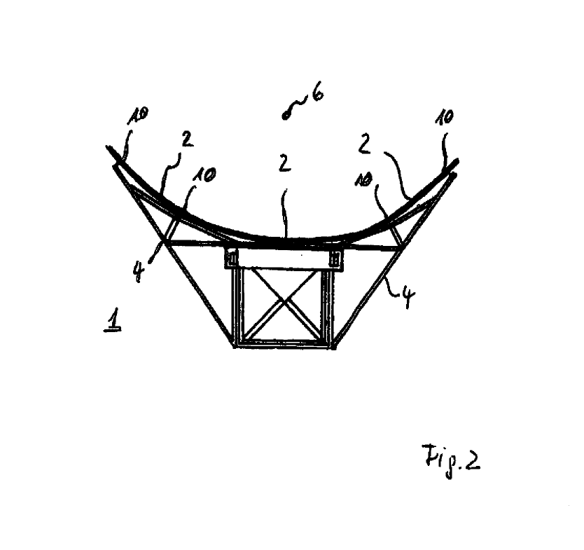

FIG. 2 the solar collector module of FIG. 1 in cross-section,

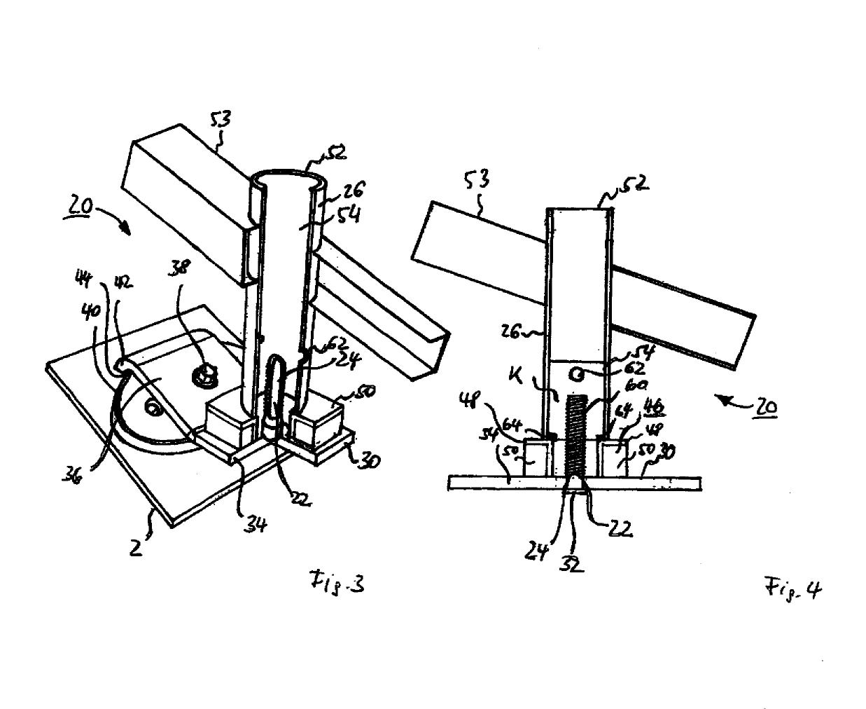

FIG. 3 a fastening system,

FIG. 4 the fastening system of FIG. 3 in cross-section,

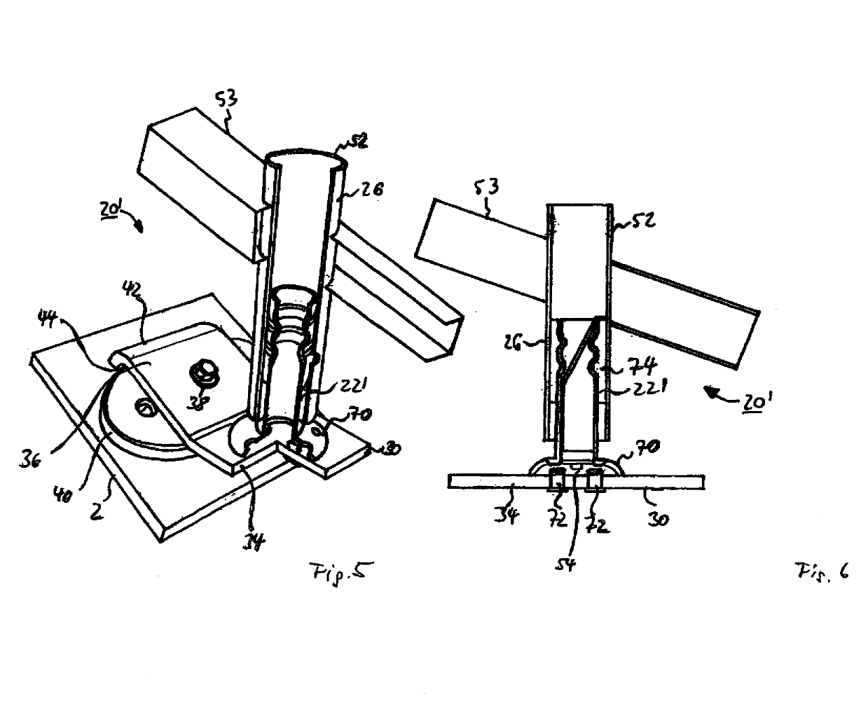

FIG. 5 an alternative fastening system,

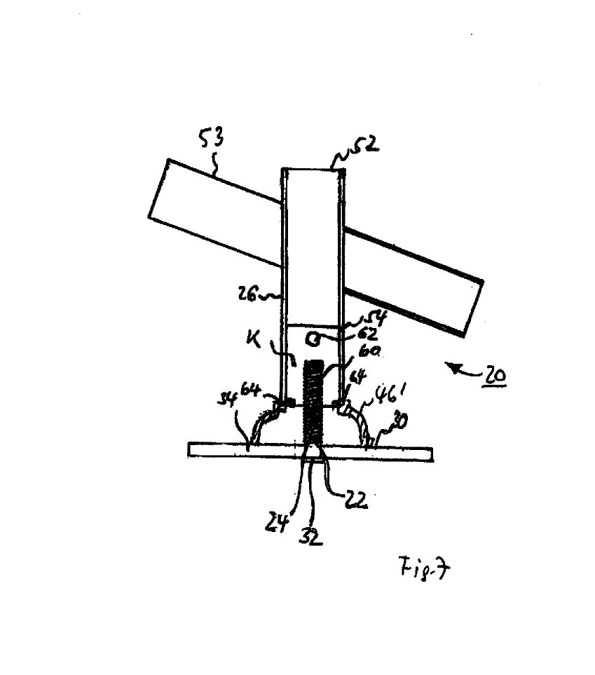

FIG. 6 the fastening system of FIG. 5 in cross-section,

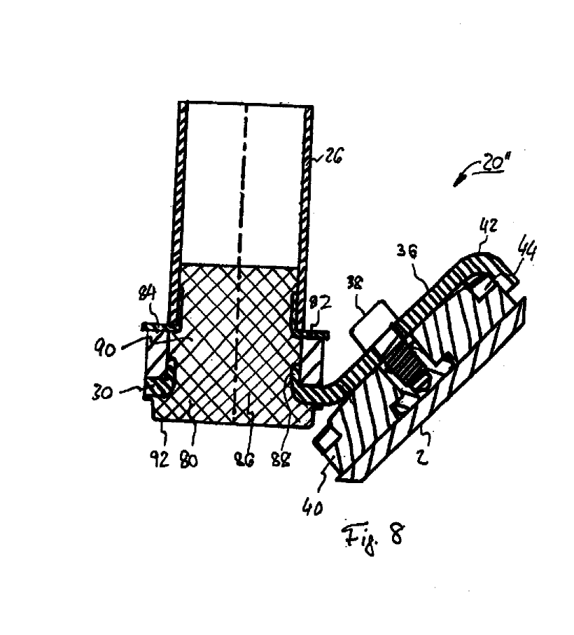

FIG. 7 the fastening system of FIG. 4 with an alternate buffer element in cross-section, and

FIG. 8 an alternative fastening system in cross-section.

Identical parts are designated in all Figures with identical reference numerals.

The solar collector module 1 according to FIG. 1 is intended for use in a so-called parabolic trough power plant. It includes a plurality of mirror elements 2 which in their entirety form a parabolic mirror and are arranged on a support frame 4. The solar collector module 1 is designed for installation with its longitudinal axis in north-south direction, wherein the support frame 4 is pivotally mounted, so that the parabolic mirror formed by the mirror elements 2 can uniaxially follow the sun. The parabolic mirror formed by the mirror elements 2 hereby concentrates the incident solar radiation onto its focal line in which an absorber tube 6 is arranged. A suitable heat carrier flows through the absorber tube 6 which is connected, in a manner not illustrated, with the downstream power plant components, where the heat introduced by the solar radiation is transformed into other forms of energy.

For a high efficiency of the parabolic trough power plant, a highly accurate and precise configuration of the solar collector module 1, in particular with respect to the arrangement of the mirror elements 2 on their support frame 4, is an important design goal. As shown in the cross-sectional view in FIG. 2, the mirror elements 2 are secured on individual retention points 10 on the support frame 4 so that the thus formed mirror surface forms in cross-section a parabola with a suitably selected focal line, corresponding to the installation location for the absorber tube 6. To ensure a highly precise alignment of the mirror elements 2 for maintaining sleep predetermined line of the parabola even when assembled at a central assembly location independent of the predetermined installation location, the mirror elements 2 are secured on the retention points 10 of the support frame 4 with high precision and by carefully avoiding introduction of stresses or forces.

For this purpose, a suitable fastening system 20 is provided at the retention points 10, as shown in FIG. 3 in a side view and in FIG. 4 in cross-section. The fastening system 20 is hereby designed for the desired stress-free and force-free connection of components mirror element 3, on one hand, and support frame 4, on the other hand, for the use of an adhesive bond. The fastening system 20 includes as essential connecting elements on one hand a locking pin 22, in the exemplary embodiment formed by a screw 24, and a casing 26, in the exemplary embodiment formed by a tube section, surrounding the locking pin 22 and forming a receiving channel for the locking pin 22.

The locking pin 22, in the exemplary embodiment in the form of the screw 24, is arranged on a base plate 30. As indicated in the cross-sectional view in FIG. 4, the screw 24 forming the locking pin 22 passes through a suitable bore through the base plate 30, wherein the screw head 32 positively rests against the base plate 30. The diagram of FIG. 3 shows that the base plate 30 has a the first contact plate 34 for receiving the locking pin 22, to which an additional contact plate 36 is connected in an angled configuration. The base plate is in the region of the additional contact plate 36 detachably connected via a connecting bolt 38 with a retaining element 40, which in turn is adhesively bonded to the mirror element 2. To facilitate installation, the other contact plate 36 has an assembly stop 44 in the form of a fold 42, which in the installed state rests against the edge of the retaining element 40.

The casing 26 which in the exemplary embodiment is embodied as a pipe section allows, on one hand, secure attachment on the other component, i.e. the support frame 4, for example by welding. A buffer element 46 made of a relatively soft material, in the exemplary embodiment made of foam, is arranged between the end opening of the casing 26 and the base plate 30.

During installation of the solar collector module 1, i.e. during attachment of the respective mirror element 2 to the support frame 4, the base plate 30 is first attached to the mirror element 2 like a pre-assembly in the region of the second contact plate 36 by way of the connecting bolt 38 and the retaining member 40. The casing 26 is constructed as an integral part of the support frame 4, for example as an end piece of a tube element of the framework 4, and is preferably arranged centrally in the profile within the respective support frame. Thereafter, the mirror element 2 is suitably positioned relative to the support frame 4, wherein in the region of the fastening system 20 the locking pin 22 formed by the screw 24 is inserted into the receiving channel inside the casing 26. The fine adjustment and high-precision alignment of the mirror element 2 in relation to the support frame 4 can be performed while the locking pin 22 is already received in the receiving channel, since in this phase the locking pin 22 can move freely in the receiving channel of the casing 26. In the sideways or lateral direction in relation to the base plate 30, the locking pin 22 can then be positioned in the receiving channel with high accuracy in the manner of X-Y positioning. As viewed in the longitudinal direction of the locking pin 22, i.e. in the “Z-direction”, the base plate 30 can also move relative to the casing 26 for high-precision alignment in this direction.

The buffer element 46 is hereby more or less compressed due to its elasticity, while still establishing a material-side connection between the end-side opening of the receiving channel located in the casing 26 and the base plate 30. The buffer element 46 which is preferably made of a foam material element, in particular of a closed-pore foam material, is advantageously attached on the base plate 30 during installation as a pre-assembly, for example by adhesive bonding and/or a release liner, before being joined with the casing 26. Because the buffer element 46 is made of closed-cell foam, the cured adhesive is mostly protected from moisture during the subsequent operation of the system, thus guaranteeing enhanced durability. On the other hand, the buffer element 46 may be also made of an open-cell foam. This ensures in particular that the restoring forces generated in the assembly during the compression of the buffer element do not become too large, and thus do not adversely affect the accuracy of the installation. Preferably, the buffer element 46 is constructed so as to satisfy both requirements, i.e. a moisture protection for the adhesive and relatively low restoring forces. For this purpose, the buffer element 46 is formed from a suitably selected combination of open-cell and closed-cell fractions, wherein the respective composition ratios and/or the pore sizes are suitable selected to meet the specific requirements.

In particular, the buffer element 46 is hereby constructed from multiple components, wherein a first component 48 is intentionally designed for at least temporarily sealing the receptacle formed by the base plate 30 and the casing 26 to be filled with liquid adhesive. Accordingly, the first component 48 forms a sealing barrier with a comparatively high density compared to the adhesive and extends spatially along the entire inwardly oriented surface of the buffer element 46. Conversely, a second component 50 is preferably intentionally designed for receiving the aforementioned deformation and correspondingly with a comparatively high deformability and correspondingly higher elasticity. In the exemplary embodiment, where the buffer element 46 is constructed based on a foam material, the first component 48 is constructed with closed pores, whereas the second component 50 is comparatively open-pore or mixed-pore. The components 48, 50 are thereby materially connected with each other, in particular glued or welded. The buffer element 46 formed of the components 48, 50 can alternatively also be produced with a suitable process, for example by coextrusion. Even when the components 48, 50 are made of the same base material, the comparatively closed-poor embodiment of the first component 48 requires a correspondingly higher density compared to the adhesive, so that the first component 48 has a higher density than the second component 50.

The connection to the support frame 4 is carried out in particular by attaching the rear end 52 of the casing 26 to a support tube 53, which is part of the support frame 4. The rear end 52 is hereby preferably inserted through the support tube 53 and suitably fixed in the end position, in particular welded. The rear end 52 of the casing 26 is preferably inserted “perpendicular” in the corresponding receiving opening in the support tube 53, i.e. parallel to the installation direction by lowering, wherein all the pipe sections (for each mirror) are preferably inserted parallel and simultaneously, i.e. in particular in a single operating step.

After the precise alignment of the mirror element 2 and the support frame 4, as shown in particular in the cross-sectional view of FIG. 4, the receiving channel of the casing 26 may be filled from its rear end 52 with adhesive K. Following the exact adjustment and alignment, in particular by using the buffer element 46, the casing 26 together with the base plate 30, and in particular with buffer element 46 acting as a seal, form a receptacle 54 for the liquid adhesive K. The adhesive can thus be freely and particularly easily introduced into the receptacle 54, without introducing stresses, forces or the like into the system. Subsequently, the filled adhesive K can cure and thus form a material connection between the locking pin 22 and the inner surface of the casing 26. Moreover, the receptacle 54 formed by the cooperation of the base plate 30 and casing 26 can preferably be filled with a sufficiently large amount of the adhesive so that the adhesive completely surrounds the locking pin 22 protruding into the receiving channel in the casing 26. This ensures that forces or torques are never transmitted at any location of the force- and torque-transmitting system exclusively via the locking pin held 22, which has a much smaller cross-section than the thin casing 26.

The thereby achievable increased stability against lateral forces can be particularly important in view of the potentially relatively large distances between the components to be joined, in particular to the support frame 4, covering, for example, up to 250 mm. In addition, the locking pin 22 is after installation, as also clearly visible in FIG. 4, largely protected from corrosion due to the complete cladding with adhesive. On the other hand, the base plate 30 and the casing 26 also form an almost complete encapsulation of the adhesive. As a result, the adhesive is largely protected from incident light and radiation, and thus in particular from UV-radiation. This provides a particularly durable and long lasting adhesive in particular with regard to the intended application in solar power plants even when using adhesives that have only limited UV resistance.

This connection is, after curing of the adhesive K and especially in view of the mechanical contact between the casing 26, on one hand, and the base plate 30, on the other hand, comparatively stable against compressive loading and transverse forces. However, to ensure also high stability to tensile loads, the material connection formed by the adhesive body and the contacting connecting parts, namely the locking pin 22 on one hand and the inner surface of the casing 26 on the other hand, can be enhanced by suitably shaping the components, in particular by forming undercuts or the like. Optionally, the locking pin 22 and/or the casing 26 may be roughened or contoured at their respective surfaces intended for connection to those parts having the adhesive. In the exemplary embodiment, the screw thread 60 of the screw 24 forming the locking pin 22 has such surface contouring. Such surface suitable for an intimate engagement with the adhesive of the adhesive body is provided by the transverse surface grooves extending through the screw thread 60.

Alternatively or additionally, additional surface elements may be provided to increase the tensile strength, for example in the form of circumferential grooves, recesses or the like. In the illustrated embodiment, openings 62 are present in the casing 26 into which the adhesive may enter before curing, thereby forming undercuts. Furthermore, the casing 26 may have in the region of its end opening a suitable cross-sectional constriction, such as an inwardly extending flange 64.

The casing 26 may possibly be non-circular, to take into account that the requirements for the diameters capable of compensating the given tolerances are not “isotropic”. Particular, due to the design, the tolerance in the support system along the parabolic trough may be greater (lower stiffness the support system). Such “non-circular” profile could therefore be elliptical, rectangular, etc. Optimization of the profile reduces/limits adhesive consumption. The tube may also be round, for example, in the connecting region to the support (due to holes) and may transition in the connecting region to the pin to an ellipse or an approximate rectangle.

It is generally assumed in the design of the fastening system 20 that, (only) three-axis compensation is necessary in the main axis, which is divided into a “Z-compensation” (longitudinal displacement of the locking pin 22 relative to the casing 26), on the one hand, and an “X-Y compensation” or a surface joint (transverse displacement of the locking pin 22 within the casing 26), on the other hand. An alternative embodiment of a suitable fastening system 20′ based on the formation of an adhesive bond which allows an even further breakdown of these compensation components, is shown in FIG. 5 in a side view and in FIG. 6 in cross-section. The locking pin 22′ intended for the introduction into the receiving channel in the casing 26 is also constructed here as a hollow component and is fastened in its contact or foot region on the base plate 30 by way of a mounting plate 70. When arranged on the base plate 30, it forms together with the base plate 30 in its interior space the receptacle 54 for the liquid adhesive, wherein the tensile force of this adhesive bond is established by a plurality of locating screws 72 penetrating base plate 30 into the interior space. For fixing this alternative locking pin 22′ relative to the casing, the intermediate space 74 between locking pin 22′ and the casing 26 may be fill with an adhesive. In this embodiment, the receiving space for the adhesive is therefore divided into two partial chambers, namely the receptacle 54, on one hand, and the intermediate space 74, on the other hand.

This embodiment is thus particularly advantageous when a particularly large compensation for positioning the components is desired or required for substantial tolerance compensation. The division into “Z- compensation”, on one hand, and “X-Y- compensation”, on the other hand, hereby takes place by longitudinal displacement of the inserted locking pin 22′ within the casing 26, on one hand, and by placing the mounting plate 70 on the base plate 30, on the other hand. A slight angle adjustment, which may still be necessary, can be accomplished by way of the adhesive joint between the mounting plate 70 and the base plate 30.

A retaining wire 76 is also provided as an installation aid. A sealing sleeve 78 is also located in the lower part of the tube between the inner tube and the outer tube. This material and dimensions of the sealing sleeve are preferably selected so that the sealing sleeve is firmly seated during installation, whereas the inner tube can easily slide, optionally assuming the bottom position in a vertical orientation by gravity alone. Falling out is prevented in this embodiment by the retaining wire 76. This concept is characterized in particular by lower consumption of adhesive, since no correction by way of “volume” is required.

In an alternative preferred embodiment, the system can also be implemented without the retaining wire 76. In this version, the sealing sleeve 78, in particular with regard to its size and/or selection of material, is constructed so that it is seated at a fixed position relative to the outer tube, but can relatively easily slide on the inner tube. The frictional connection of the sealing sleeve 78 to the inner tube is in this embodiment sized so as to prevent, for example, gravity-induced falling out.

An alternative embodiment of the buffer element 46′ of the fastening system 20 is shown in FIG. 7 in cross-section. With otherwise identical components of the fastening system 20, the buffer element 46′ is constructed with respect to its three-dimensional shape in the manner of a bell or sleeve. As shown in the cross-sectional diagram of FIG. 7, the buffer element 46′ has in this embodiment the form of a channel with a widening longitudinal cross-section. With such a shape, the requirements, particularly with respect to deformability, sealing, compensation of tolerances, relatively low residual forces and the like, are primarily satisfied by the geometry of the buffer element 46′ and possibly additionally by the choice of materials. When a suitably flexible material is used, suitable shaping ensures absorption of longitudinal as well as lateral forces via a suitable deformation of the channel wall, without causing excessively large restoring forces in the end portions of the buffer element 46′.

FIG. 8 shows an alternative fastening system 20″ in cross-section, which may be constructed by omitting the locking pin 22. In this fastening system, the connector body 80 produced by curing the adhesive provides the force-locking and torque-transmitting connection of the components with one another. The components are designed so that the connector body 80 produced by curing the adhesive and having a shape defined by the shape of the receptacle 54 is contoured on both sides in the form of a stamp, and is thus positively connected both to the casing 26 and the base plate 30.

On the one hand, the casing 26, which may for example be constructed as a square tube, may be provided on its free end forming the mouth of the receiving channel with a shaped body 82, for example a welded or pressed deep-drawn bushing. The shaped body 82 has a smaller internal cross-section compared to the internal cross-section of the receiving channel, so that an undercut is formed in the transition region from the shaped body 82 to receiving channel. The shaped body 82 thus produces in the receiving channel a cross-sectional constriction in the mouth region, so that a form-fitting connection is produced in this region at the connecting element 80. The external part of the shaped body 82 is additionally provided with a circumferential collar 84, which bears on the buffer element 46 during installation of the system and closes the gap even when utilizing tolerances in the x- or y-direction.

On the other hand, the base plate 30 is designed in this embodiment as a deep-drawn or pressed component having a passage opening 86 for the liquid adhesive the provided contact region to the casing 26. The passage opening 86 is provided on the side of the base plate 30 facing the casing 26 with an upwardly projecting circular collar 88, on the outside of which the buffer element 46, which is in this example ring-shaped, is adhesively bonded. Due to the relatively flexible buffer element 46, the gap can be reliably held closed in this embodiment even when the components are to be joined together with varying z-distances. The buffer element 46, which in the exemplary embodiment is designed as a foam element, is configured in terms of material selection and geometry parameters such that, with a maximum utilization of the tolerance in the longitudinal direction of the receiving channel (z-direction), the upper edge of the circumferential collar 88 arranged on the base plate 30 can be moved to the point of contact, i.e. direct mechanical contact, to the end face of the peripheral collar 84 of the shaped body 82. The residual thickness of the compressed buffer element 46 is then located outside this region. This ensures that the unobstructed potting cross-section defined by the gap 90 between the circumferential collar 84 and the circumferential collar 88 can be kept as short as possible in the z-direction, so as to accommodate optimization of the material loading.

To reliably seal the receptacle 54 provided as a mold for the liquid adhesive toward the side of the base plate 30 facing away from the casing 26 and to create a form fit of the connector body 80 with the base plate 30, the base plate 30 is also in this example provided on its side facing away from the casing 26 with a base well 92 in the region of the passage opening 86. This base well 92 has a greater internal cross-section compared to the passage opening 86, thereby producing the desired undercut of the connector body 80 with the base plate 30, and may be made, for example, from welded deep-drawn sheet metal or of glued plastic or another suitable material. Alternatively, the components formed by the base plate 30 and base well 92 may also be made in one piece, for example as a cast body.

### LIST OF REFERENCE NUMERALS

1 Solar collector module
2 Mirror element
3 Support frame
6 Absorber tube
10 Retaining points
20, 20′ Fastening system
22, 22′ Locking Pin
24 Screw
26 Casing
30 Base plate
32 Screw head
34 Contact plate
36 Contact plate
38 Connecting screw
40 Retaining element
42 Fold
44 Assembly stop
46 Buffer element
48, 50 Components
52 Rear end
54 Receptacle
60 Screw thread
62 Opening
64 Flanging
70 Mounting plate
72 Locating screw
74 Intermediate space
76 Retaining wire
78 Sealing bushing
80 Connector body
82 Shaped body
84 Circumferential collar
86 Through opening
88 Circumferential collar
90 Gap
92 Base well

What is claimed is:

1-16. (canceled)

17. A fastening system for connecting two components, comprising:
a base plate constructed for attachment to a first of the two components, and
a casing constructed for attachment to a second of the two components and forming a receiving channel for a connector body, with the casing together with the base plate forming a receptacle for liquid adhesive.

18. The fastening system of claim 17, wherein the base plate comprises an upwardly projecting locking pin, and wherein the receptacle is formed only after the locking pin is inserted in the receiving channel.

19. The fastening system of claim 18, wherein the locking pin has a contoured surface.

20. The fastening system of claim 19, wherein the contoured surface is constructed as a screw thread.

21. The fastening system of claim 19, wherein an inner surface of the receiving channel of the casing in which the locking pin is inserted has a contoured surface.

22. The fastening system of claim 18, wherein the locking pin is made of a material that is softer than a material of the casing.

23. The fastening system of claim 17, wherein the receiving channel disposed in the casing comprises an undercut region which has an enlarged internal cross-section in comparison with a mouth portion facing the base plate.

24. The fastening system of claim 17, wherein the base plate comprises in a contact area with the casing a passage opening for the liquid adhesive, and further comprises a base well in a region of the passage opening on a side of the base plate facing away from the casing.

25. The fastening system of claim 17, wherein the casing comprises a cross-sectional constriction for the receiving channel, said constriction disposed in an end region of the receptacle.

26. The fastening system of claim 17, further comprising a buffer element constructed for attachment between the casing and the base plate, wherein the buffer element is made of a material having greater elasticity than a material of at least one of the base plate and the casing.

27. The fastening system of claim 26, wherein the buffer element is made of several components, wherein a first component of the buffer element has lower elasticity or ductility and higher density than a second component of the buffer element.

28. The fastening system of claim 26, wherein the buffer element is constructed as a bell or a sleeve.

29. The fastening system of claim 17, wherein the base plate comprises a first contact plate for connection to the casing and a second contact plate for attachment to a respective first or second component.

30. The fastening system of claim 29, wherein the second contact plate is mounted at an angle with respect to the first contact plate.

31. The fastening system of claim 29, wherein the second contact plate comprises an assembly stop.

32. A solar collector module comprising:
a support frame,
a plurality of mirror elements fastened to the support frame with fastening systems connecting two components, with each fastening system comprising a base plate constructed for attachment to a first of the two components, and a casing constructed for attachment to a second of the two components and forming a receiving channel for a connector body, with the casing together with the base plate forming a receptacle for liquid adhesive.

33. A method for fastening a mirror element on a support frame, comprising:
attaching a base plate on the mirror element, and
attaching a casing on the support frame,
adjusting the mirror element and the support frame relative to each other, such that the casing in conjunction with the base plate forms a receptacle for a liquid adhesive, and
filling the receptacle with the liquid adhesive.

34. The method of claim 33, wherein the mirror element is of a solar collector module.
